(19) United States
(12) Patent Application Publication
(10) Pub. No.: US 2017/0268312 A1
(43) Pub. Date: Sep. 21, 2017

(54) ADJUSTABLE RHEOLOGICAL WELL CONTROL FLUID

(71) Applicant: Halliburton Energy Services, Inc., Houston, TX (US)

(72) Inventor: Russell Stephen Haake, Dallas, TX (US)

(21) Appl. No.: 15/505,203

(22) PCT Filed: Oct. 16, 2014
(86) PCT No.: PCT/US2014/060960

§ 371 Date: Feb. 20, 2017

(51) Int. Cl. E21B 33/13; E21B 47/06; E21B 43/26; C09K 8/62; C09K 8/50

(52) U.S. Cl. CPC E21B 33/13; C09K 8/62; C09K 8/50; E21B 43/26; E21B 47/06

(57) ABSTRACT

A method includes introducing a well control fluid at a first viscosity into a downhole portion of a wellbore, where the well control fluid includes an electrorheological or magnetorheological fluid. In response to a wellbore inflow condition, the method includes activating the well control fluid to change the viscosity of the well control fluid to a second, higher viscosity.

### BACKGROUND

The present disclosure relates to well control fluids in wellbore testing operations, and more particularly to treating a fractured wellbore with a well control fluid.

Well control fluid, such as kill weight fluid, can be used in wellbore testing operations to reduce permeability of an accidentally fractured formation, for example, by plugging fractures in the wellbore to restrict fluid loss out of the wellbore. Sometimes, the well control fluid is a dense, thick-gel solution that is pumped through a testing string of a well system to a downhole location proximate the formation fractures to slow fluid flow through the formation fractures. Well control fluids often vary in viscosity, and are selected based on their viscosity and on pressure data collected during well testing operations.

### DESCRIPTION OF DRAWINGS

FIG. 1 is a schematic partial cross-sectional view of an example well system.

FIG. 2A is a schematic partial cross-sectional side view of an example downhole testing assembly.

FIG. 2B is a schematic view of an example downhole testing tool.

FIG. 3 is a flowchart showing an example process for responding to a wellbore inflow condition.

FIG. 4 is a flowchart showing an example process for responding to an unintended fluid inflow into a wellbore.

Like reference symbols in the various drawings indicate like elements.

### DETAILED DESCRIPTION

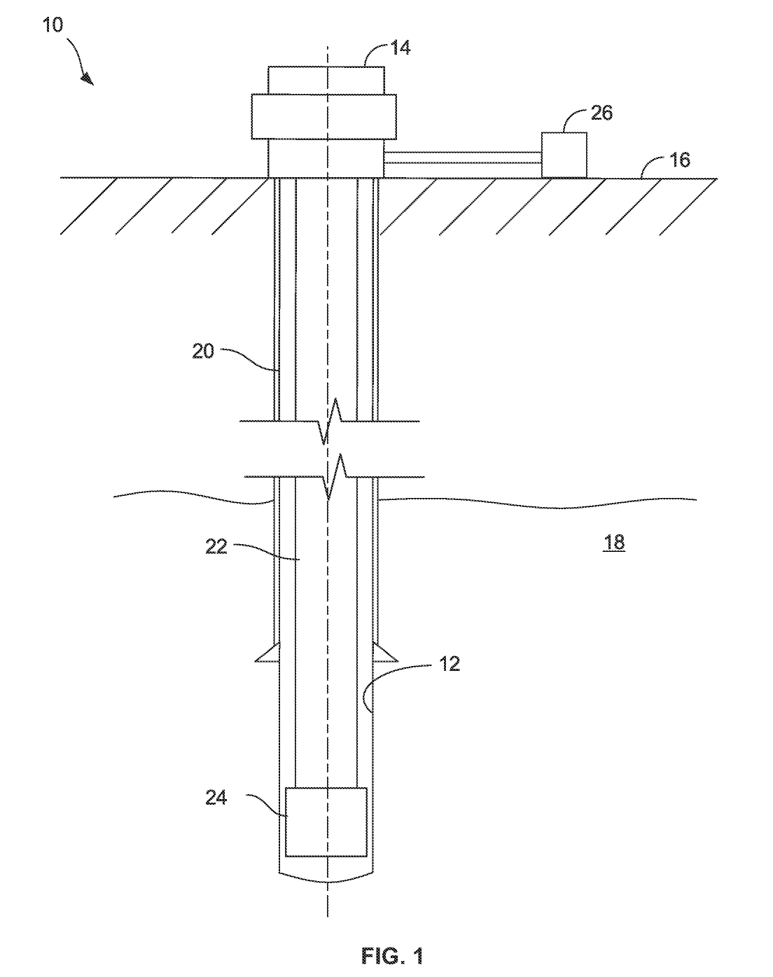

FIG. 1 is a schematic partial cross-sectional view of an example well system 10 that generally includes a substantially cylindrical wellbore 12 extending from a wellhead 14 at the surface 16 downward into the Earth into one or more subterranean zones of interest (one subterranean zone of interest 18 shown). The subterranean zone 18 can correspond to a single formation, a portion of a formation, or more than one formation accessed by the well system 10, and a given well system 10 can access one, or more than one, subterranean zone 18. After some or all of the wellbore 12 is drilled, a portion of the wellbore 12 extending from the wellhead 14 to the subterranean zone 18 is lined with lengths of tubing, called casing 20. The wellbore 12 can be drilled in stages, and the casing 20 may be installed between stages. The depicted well system 10 is a vertical well, with the wellbore 12 extending substantially vertically from the surface 16 to the subterranean zone 18. The concepts herein, however, are applicable to many other different configurations of wells, including horizontal, slanted or otherwise deviated wells, and multilateral wells with legs deviating from an entry well.

A well string 22 is shown as having been lowered from the surface 16 into the wellbore 12. In some instances, the well string 22 is a series of jointed lengths of tubing coupled together end-to-end and/or a continuous (i.e., not jointed) coiled tubing. The well string 22 can include a well testing string with one or more well tools, including a downhole testing assembly 24. The downhole testing assembly 24 can include, for example, a wellbore testing tool. Testing fluid, well control fluid, and/or other types of fluid can be communicated to the downhole testing assembly 24 from a testing fluid source 26 at a surface location of the well. The testing fluid source 26 is fluidly coupled to the downhole testing assembly 24, for example, via the well string 22. In the example well system 10, the wellbore 12 is completing a drill stem test (DST), where the wellbore 12 has been accidentally fractured and is experiencing fluid ingress from the formation into the wellbore 12.

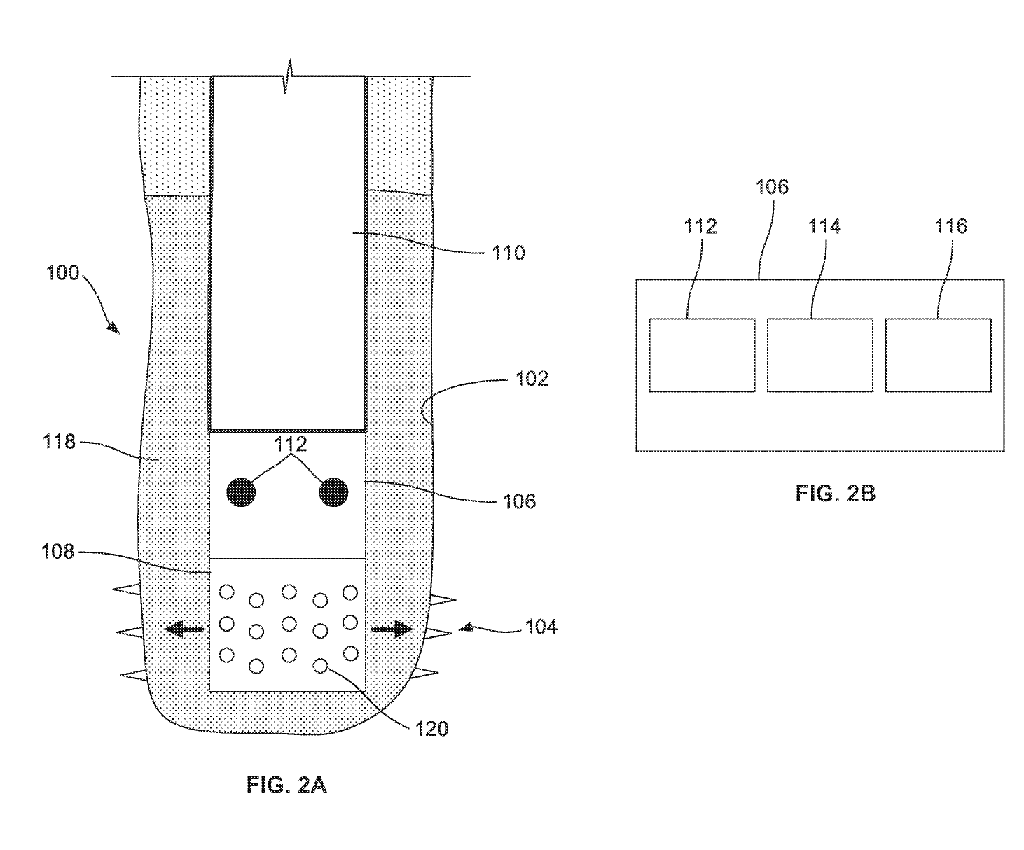

FIG. 2A is a schematic partial cross-sectional side view of an example wellbore testing tool 100 that can be used in the downhole testing assembly 24 of FIG. 1. The example wellbore testing tool 100 is in in a wellbore 102 experiencing a wellbore inflow condition defined by fluid ingress through fractures 104 in the wellbore 102. In some instances, the fractures 104 are accidental, hydraulically induced formation fractures. The example wellbore testing tool 100 includes an upper housing 106 and a lower housing 108, each fluidly coupled to a fluid pathway of a well string 110 through which fluid can be communicated from an uphole location (e.g., from a surface of a well) to a downhole location in the wellbore 102. FIG. 2B is a schematic view of the upper housing 106 of wellbore testing tool 100, showing in-well electrodes 112, an in-well power source 114 (e.g., in-well battery), and an in-well communications link 116 (e.g., telemetric communications link) located in the upper housing 106. The upper housing 106 can include additional or different components than those depicted in FIG. 2B. Referring to FIGS. 2A and 2B, a well control fluid 118 at a first rheological property (e.g., first viscosity) is activated to retain a second rheological property (second, higher viscosity) that causes the well control fluid 118 to become more dense and/or viscous. In some instances, the electrodes 112 are activated to cause an electric field, magnetic field, and/or another type of potential on the well control fluid 118 that passes through the upper housing 106 and lower housing 108 (e.g., through perforations 120 in the lower housing 108), and into the wellbore 102. Although FIGS. 2A and 2B show electrodes 112 in the upper housing 106, the upper housing 106 can include an additional or different in-well electric field source, magnetic field source, and/or other potential source to cause an electric field, magnetic field, and/or other potential on the well control fluid 118. For example, the upper housing 106 can include electrified or magnetized plates on opposite ends within the upper housing 106 to effect an electric or magnetic field on the well control fluid 118 passing through the upper housing 106. In some instances, the in-well electric field source, in-well magnetic field source, and/or other in-well potential source is adjacent the fractures 104.

The well control fluid 118 has a particular rheological property (e.g., specified viscosity) adjustable by the electric field, magnetic field, and/or other potential applied by the electrodes 112 of in the upper housing 106. For example, the well control fluid 118 can include a ferrofluid, a ferrofluid additive, a chemical sealant, a gel, and/or another type of fluid that, for example, becomes more viscous (or less viscous) based at least in part on a magnitude of an applied electric field, magnetic field, and/or other potential on the well control fluid 118. In some instances, the well control fluid 118 is pumped through the well string 110 to the wellbore testing tool 100 at a first viscosity (e.g., a low viscosity), and introduced to an electric field, magnetic field, or other potential via the electrodes 112 in the upper housing 106 in order to retain a second, higher viscosity to restrict fluid flow (e.g., fluid ingress) through the fractures 104 in the wellbore 102. In certain instances, the well control fluid 118 at the second, higher viscosity maintains a pressure in the wellbore 102 below a fluid ejection threshold. The fluid ejection threshold, for example, is a pressure threshold that retains fluid in the wellbore 102 from ejecting the wellbore 102 at a surface of the well. In other words, the well control fluid 118 at the second, higher viscosity can help balance a fluidic pressure in the wellbore 102 such that fluid ingress through the fractures 104 does not increase wellbore pressure greater than a hydrostatic head of the wellbore 102 can maintain. In some examples, the well control fluid 118 at the second, higher viscosity is denser than fluid entering the wellbore during fluid ingress, for example, such that the well control fluid 118 restricts the fluid from entering the wellbore through a formation fracture. In certain instances, pumping the well control fluid 118 at the first viscosity through the well string 110 is easier than pumping the well control fluid 118 at the second, higher viscosity through the well string 110.

In some instances, a magnitude of the electric field, magnetic field, and/or other potential applied by the electrodes 112 can be adjusted (e.g., in real time) to effect a third viscosity of the well control fluid 118. For example, a magnitude of the electric field, magnetic field, and/or other potential can be increased to effect a third viscosity of the well control fluid 118 that is greater than the second viscosity. Increasing the viscosity of the well control fluid 118 can, in some instances, more effectively slow or stop fluid loss and/or fluid ingress though the fractures 104 of the wellbore 102. For example, when the electric field, magnetic field, and/or other potential causes the well control fluid 118 to take on the second viscosity but there is still significant fluid loss or fluid ingress through the fractures 104 in the wellbore 102, the magnitude of the electric field, magnetic field, and/or other potential may be increased to effect the increased third viscosity of the well control fluid 118. In some examples, the magnitude of the electric field, magnetic field, and/or other potential can be decreased from the second viscosity to an intermediate viscosity that is between the first viscosity and the second, higher viscosity. For example, when the well control fluid 118 takes on the second viscosity, the well control fluid 118 may cause new fractures and/or expand the existing fractures 104 in the wellbore 102. Therefore, the magnitude of the electric field, magnetic field, and/or other potential can, in some instances, be reduced to decrease the viscosity of the control fluid to the intermediate viscosity, for example, to avoid additional or expanded wellbore formation fractures.

Activation of the electrodes 112 to apply the electric field, magnetic field, and/or other potential on the well control fluid 118 can vary. In some instances, activation of the electrodes 112 is like an on-off switch. For example, the electrodes 112 can be activated by communicating power to the electrodes from the power source 114 based on well operator commands (e.g., via telemetry, wired, wireless, and/or other communication), a rupture disk or other pressure-sensitive device responsive to a specified downhole pressure, an in-well hydrocarbon detection sensor responsive to hydrocarbon presence in the wellbore, and/or other. In certain instances, a well operator can control the magnitude of the electric field, magnetic field, and/or other potential via commands from a well control station at a surface of the well communicated via telemetric communications link, wired connection, wireless connection, a combination of these, and/or other.

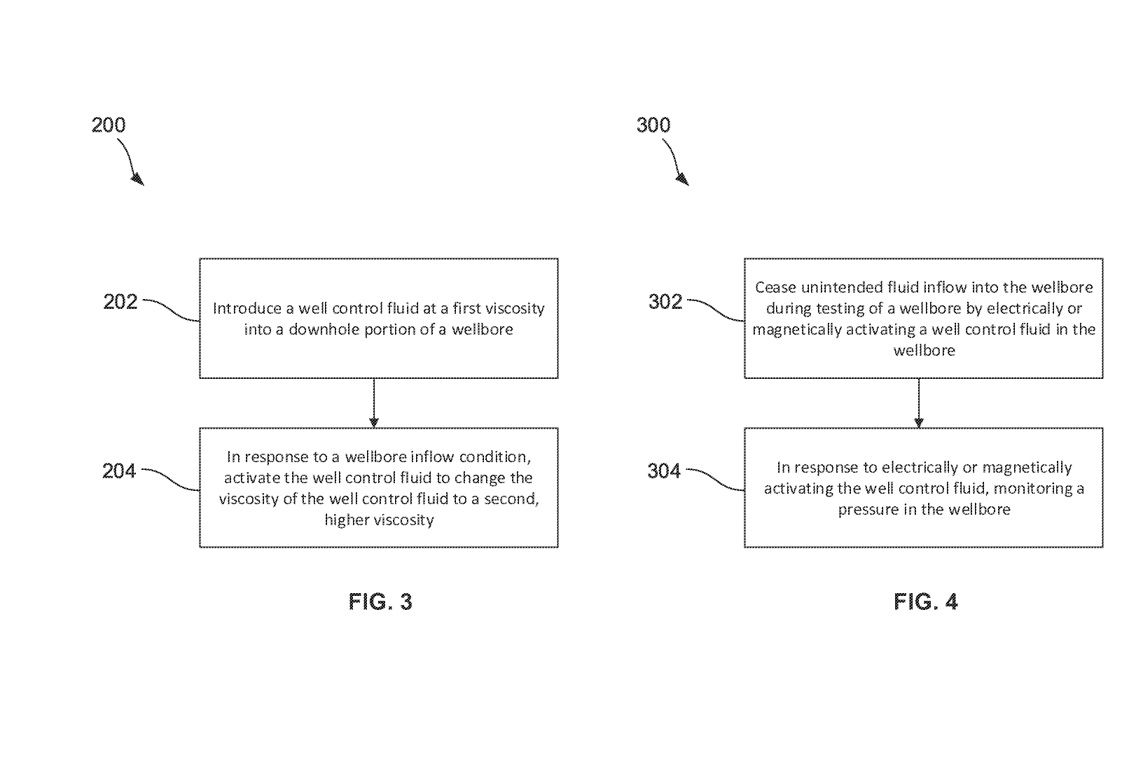

FIG. 3 is a flowchart showing an example process 200 for responding to a wellbore inflow condition, for example, using the example wellbore testing tool 100 of FIG. 2A. At 202, a well control fluid is introduced at a first viscosity into a downhole portion of a wellbore. Rheological characteristics of the well control fluid allow for manipulation of a rheological property of the well control fluid, such as viscosity, based on an electric field, magnetic field, and/or other potential applied on the well control fluid, for example, as the fluid passes through the wellbore testing tool and into the wellbore. In some instances, the well control fluid includes an electrorheological fluid, a magnetorheological fluid, a combination of these, and/or another fluid, for example, responsive to a magnetic field, an electric field, and/or another potential subjected on the well control fluid. In certain implementations, the well control fluid includes a ferrofluid responsive to a magnetic potential to increase or decrease a viscosity of the ferrofluid when subjected to a magnetic field. At 204, in response to a wellbore inflow condition, the well control fluid is activated to change a specified rheological property of the well control fluid. In some instances, the specified rheological property is the viscosity of the well control fluid, where activating the well control fluid includes increasing the viscosity of the well control fluid to a second, higher viscosity. In some instances, a wellbore inflow condition includes fluid entering the wellbore through one or more formation fractures in the wellbore. For example, formation fractures may occur, intentionally or accidentally, during testing of the wellbore when the wellbore is subjected to specified testing pressures. In some examples, portions of a wellbore experience a pressure greater than the wellbore portions can withstand, causing accidental fractures in the walls of the wellbore. In some examples, additional pressure from a dense fluid (e.g., kill weight fluid, clean-out fluid, and/or other) can cause fractures in the wellbore. In certain instances, the well control fluid can be deactivated to return the well control fluid to an original viscosity, for example, prior to being circulated through, removed, and/or recovered from the wellbore.

FIG. 4 is a flowchart showing an example process 300 for responding to an unintended fluid inflow into a wellbore, for example, using the example wellbore testing tool 100 of FIG. 2A. At 302, during testing of a wellbore, unintended fluid inflow into the wellbore is ceased by electrically or magnetically activating a well control fluid in the wellbore. In some instances, unintended fluid inflow includes fluid entering the wellbore through a hydraulically induced formation fractures in the wellbore, for example, fractures 104 in the wellbore 102 of FIG. 2A. At 304, in response to electrically or magnetically activating the well control fluid, a pressure in the wellbore is monitored. Monitoring the pressure in the wellbore can include, for example, measuring an in-well fluid pressure at the unintended fluid inflow and/or measuring a hydrostatic head pressure of a wellbore.

In view of the discussion above, certain aspects encompass a method including introducing a well control fluid at a first viscosity into a downhole portion of a wellbore, where the well control fluid includes an electrorheological or magnetorheological fluid. In response to a wellbore inflow condition, the method includes activating the well control fluid to change the viscosity of the well control fluid to a second, higher viscosity.

Certain aspects encompass a method including introducing a well control fluid with an adjustable rheological property into a downhole portion of a wellbore, where the well control fluid has a first rheological characteristic. In response to fluid entering the wellbore through a formation fracture in the wellbore, the method includes activating the well control fluid to adjust the adjustable rheological property of the well control fluid to retain a second, different rheological characteristic, and where the well control fluid with the second rheological characteristic is denser than the fluid entering the wellbore through the formation fracture.

Certain aspects encompass a method including, during testing of a wellbore, ceasing unintended fluid inflow into the wellbore by electrically or magnetically activating a well control fluid in the wellbore. In response to electrically or magnetically activating the well control fluid, the method includes monitoring a pressure in the wellbore.

The aspects above can include some, none, or all of the following features. The wellbore inflow condition includes fluid entering the wellbore through a hydraulically induced formation fracture in the wellbore. Activating the well control fluid includes activating one of an electric field or a magnetic field on the well control fluid. The method includes increasing a magnitude of the electric field or magnetic field on the well control fluid to effect a third viscosity of the well control fluid that is greater than the second viscosity. The method includes decreasing a magnitude of the electric field or magnetic field on the well control fluid to effect a third viscosity of the well control fluid, where the third viscosity is greater than the first viscosity and less than the second, higher viscosity. Introducing a well control fluid at a first viscosity into a downhole portion of a wellbore includes pumping a ferrofluid at a first viscosity into a downhole portion of a wellbore. Activating the well control fluid includes activating an in-well electric field source or magnetic field source adjacent the wellbore inflow condition. Activating an electric field source or magnetic field source comprises activating electrodes in a well testing string. Activating an electric field source or magnetic field source includes providing power to the electric field source or magnetic field source via an in-well battery. Activating an electric field source or magnetic field source includes rupturing a rupture disk in response to a specified downhole pressure to allow an electric field or magnetic field to activate the well control fluid. The method includes deactivating the well control fluid to return the viscosity of the well control fluid to the first viscosity prior to circulating the well control fluid out of the wellbore. The method includes pressurizing the wellbore to a specified well test pressure and fracturing the wellbore causing the wellbore inflow condition. The method includes maintaining a pressure in the wellbore below a fluid ejection threshold in response to the wellbore inflow condition. The adjustable rheological property of the well control fluid is viscosity of the well control fluid, the first rheological characteristic is a first viscosity, and the second, different rheological property is a second, higher viscosity. The method includes deactivating the well control fluid to return the adjustable rheological property of the well control fluid to retain the first rheological characteristic. Activating the well control fluid to adjust the adjustable rheological property of the well control fluid includes activating one of an electric field or magnetic field on the well control fluid to retain the second, different rheological characteristic. Unintended fluid inflow includes fluid entering the wellbore through a hydraulically induced formation fracture in the wellbore.

A number of embodiments have been described. Nevertheless, it will be understood that various modifications may be made. Accordingly, other embodiments are within the scope of the following claims.

What is claimed is:

1. A method, comprising:
introducing a well control fluid at a first viscosity into a downhole portion of a wellbore, the well control fluid comprising an electrorheological or magnetorheological fluid; and
in response to a wellbore inflow condition, activating the well control fluid to change the viscosity of the well control fluid to a second, higher viscosity.

2. The method of claim 1, wherein the wellbore inflow condition comprises fluid entering the wellbore through a hydraulically induced formation fracture in the wellbore.

3. The method of claim 1, wherein activating the well control fluid comprises activating one of an electric field or a magnetic field on the well control fluid; and
the method comprising increasing a magnitude of the electric field or magnetic field on the well control fluid to effect a third viscosity of the well control fluid that is greater than the second viscosity.

4. The method of claim 1, wherein activating the well control fluid comprises activating one of an electric field or a magnetic field on the well control fluid; and
the method comprising decreasing a magnitude of the electric field or magnetic field to effect a third viscosity of the well control fluid, the third viscosity greater than the first viscosity and less than the second, higher viscosity.

5. The method of claim 1, wherein introducing a well control fluid at a first viscosity into a downhole portion of a wellbore comprises pumping a ferrofluid at a first viscosity into a downhole portion of a wellbore.

6. The method of claim 1, wherein activating the well control fluid comprises activating an in-well electric field source or magnetic field source adjacent the wellbore inflow condition.

7. The method of claim 6, wherein activating an electric field source or magnetic field source comprises activating electrodes in a well testing string.

8. The method of claim 6, wherein activating an electric field source or magnetic field source comprises providing power to the electric field source or magnetic field source via an in-well battery.

9. The method of claim 6, wherein activating an electric field source or magnetic field source comprises rupturing a rupture disk in response to a specified downhole pressure to allow an electric field or magnetic field to activate the well control fluid.

10. The method of claim 1, comprising deactivating the well control fluid to return the viscosity of the well control fluid to the first viscosity prior to circulating the well control fluid out of the wellbore.

11. The method of claim 1, comprising:
pressurizing the wellbore to a specified well test pressure; and
fracturing the wellbore, causing the wellbore inflow condition.

12. The method of claim 1, comprising maintaining a pressure in the wellbore below a fluid ejection threshold in response to the wellbore inflow condition.

13. A method, comprising:
introducing a well control fluid with an adjustable rheological property into a downhole portion of a wellbore, the well control fluid having a first rheological characteristic; and
in response to fluid entering the wellbore through a formation fracture in the wellbore, activating the well control fluid to adjust the adjustable rheological property of the well control fluid to retain a second, different rheological characteristic, and the well control fluid with the second rheological characteristic is denser than the fluid entering the wellbore through the formation fracture.

14. The method of claim 13, wherein the adjustable rheological property of the well control fluid is viscosity of the well control fluid, the first rheological characteristic is a first viscosity, and the second, different rheological characteristic is a second, higher viscosity.

15. The method of claim 13, comprising deactivating the well control fluid to return the adjustable rheological property of the well control fluid to retain the first rheological characteristic.

16. The method of claim 13, wherein activating the well control fluid to adjust the adjustable rheological property of the well control fluid comprises activating one of an electric field or a magnetic field on the well control fluid to retain the second, different rheological characteristic.

17. A method, comprising:
during testing of a wellbore, ceasing unintended fluid inflow into the wellbore by electrically or magnetically activating a well control fluid in the wellbore; and
in response to electrically or magnetically activating the well control fluid, monitoring a pressure in the wellbore.

18. The method of claim 17, wherein unintended fluid inflow comprises fluid entering the wellbore through a hydraulically induced formation fracture in the wellbore.

19. The method of claim 17, wherein electrically or magnetically activating a well control fluid comprises activating an in-well electric field source or magnetic field source adjacent the unintended fluid inflow.

20. The method of claim 17, comprising electrically deactivating or magnetically deactivating the well control fluid in the wellbore prior to circulating the well control fluid out of the wellbore.
